(19) United States
(12) Patent Application Publication
(10) Pub. No.: US 2008/0256819 A1
(43) Pub. Date: Oct. 23, 2008

(54) Adjustable Expander Die for Use in Drying Elastomers

(76) Inventor: Timothy Flanery, Louisville, KY (US)

Correspondence Address: DORITY & MANNING, PA & MICHELIN NORTH AMERICA, INC, P O BOX 1449, GREENVILLE, SC, 29602-1449, US

(21) Appl. No.: 11/631,495

(22) PCT Filed: Aug. 17, 2004
(86) PCT No.: PCT/US04/26718

§ 371 Date: May 7, 2008

(51) Int. Cl. F26B 21/06

(52) U.S. Cl. 34/79

(57) ABSTRACT

An adjustable die (110) for flash drying elastomers or other materials is provided. In one exemplary embodiment, a sleeve (145) is provided that is rotatable within a housing (195). A plurality of closely spaced apertures (155) are provided upon the sleeve (145). The sleeve (145) may be rotated such that any number of the apertures (155) are adjacent to an outlet (200) in the housing (195). Materials to be flashed flow into the sleeve (145), through the apertures (155), and exit through the outlet of the housing (200). By rotating the sleeve (145) relative the housing (195), the number of exposed apertures (155) may be selected so as to control the flow rate of materials through the die (110). The rotatable sleeve (145) allows for dynamic control of process variables.

### FIELD OF THE INVENTION

The present invention relates to methodologies and apparatus for removing moisture from materials such as elastomers and particularly for removing water from an intermediate mixture of water and rubbers materials commonly used in the manufacture of tires.

### BACKGROUND OF THE INVENTION

Expeller-expander technology is a processing technique that has been available in various forms dating back to the nineteenth century. Although it should be understood that the present invention may be used in processing a variety of different materials, the present area of concern relates to that area of an elastomer processing sequence (including synthetic and natural elastomers) where a rubber material has been combined with water and now the water is to be removed.

In previously used configurations, two extruders in series have been employed to remove moisture from the rubber. Generally, the first extruder, also referred to as the expeller, squeezes the rubber between a pair of intermeshed screws. This portion of the process is generally able to reduce the moisture content from about 60% to about 15%.

Following the first stage of the drying process by the expeller, the rubber material is passed to a second extruder referred to as an expander for additional drying. This second extruder increases the pressure applied to the rubber, which consequently increases the temperature of the rubber to create a super heated liquid. As this super heated liquid is forced through the extruder, again commonly by using screw drive technology, the material is forced through dies or filter screens at the end of the screw where the moisture, or volatile matter, will flash dry.

The flash drying process corresponds to a rapid change in state from liquid to vapor as the super heated water and rubber materials are passed through the die or filter screen and suddenly returned to normal atmospheric pressure. Because the temperature is still generally significantly higher than 100 degrees Celsius, the drop in pressure causes a sudden change in state. The energy necessary to produce the flash drying phenomena is transferred to the rubber from the screw drive mechanism in the expander. This transfer of energy is made possible by the resistance of the rubber to exit the expander through the dies. The temperature and pressure on the super heated rubber and water mixture reach a maximum at the dies. For a given screw speed and rubber flow rate, the resistance, and therefore the amount of energy transferred to the rubber, is dependent on the pressure at the head.

The pressure is fixed by the pressure drop induced by the passage of the super heated rubber and water materials through the die. In a practical system, there will be a number of dies at the exit point of the expander and thus the pressure will depend on the number of dies, their geometry and aperture size. In previously employed configurations, all of these aspects of the dies were fixed with any one processing sequence. Because the prior art is a fixed and unchangeable configuration, certain production problems have occurred that the present technology addresses and overcomes.

When the super heated rubber and water material goes through the dies, the flash drying process produces decohesion of the rubber thereby creating rubber crumbs that are transported to balers for further processing. The control of the size of these crumbs is one of the aspects effecting good transportation of the rubber through the remaining processing sequences and, consequently, can have an impact on further processing. For example, conveyor fouling can occur based on production of too small a crumb size. As the currently available technology employs preset die configurations, no capability other than stopping production is available to address issues involving pressure adjustment and crumb size. Moreover, there is no capability for optimizing the overall rubber processing process outside of controlling the expeller-expander screw speed without shutting down production.

Another problem encountered with the flash drying process previously described is the production of fines—a very small and undesirable particulate. Fines can become airborne and can adhere to equipment, structures, and personnel. Accordingly, elimination or at least reduction of the amount of fines created by flash drying is desirable. While various implementations of extruder-expander technology have been developed, the present invention provides substantial improvements in addressing the problems identified above.

### SUMMARY OF THE INVENTION

In view of the recognized features encountered in the prior art and addressed by the present subject matter, an improved methodology for drying elastomeric materials has been developed. The present invention is directed to methodologies and apparatus that provide for the optimization of the pressure at the die head without the necessity of shutting down production. Adjustments can be made during operation of the flash drying process. Furthermore, a substantial reduction in fines as well as improved control of crumb size can be achieved with the present invention, particularly with certain rubber materials. Dynamic control of the overall operation of an extruder-expander system, including control of temperature and pressure, can be achieved without shutting down the system.

In one exemplary embodiment of the present invention, an adjustable die for processing rubber and water materials is provided that includes a cylindrically-shaped sleeve. The sleeve defines a plurality of proximate apertures along a first side. The sleeve also defines a single aperture along a second side that is positioned opposite the first side. The sleeve also defines an interior passage between an inlet end and an outlet end. A housing is provided that defines a conduit that is configured for the receipt of the sleeve. The housing defines an opening along one side, which is connected to the conduit. A ring gear is mechanically connected with the outlet end of the housing and is configured for rotating the sleeve relative to the housing such that the plurality of proximate apertures and the single aperture may be selectively positioned adjacent to the opening of the housing. A plug may be provided that is connected to the outlet end of the sleeve. The plug defines at least one channel in fluid communication with the interior passage. A worm gear can be provided that is in mechanical communication with the ring gear and is used to selectively position the plurality of proximate apertures and the single aperture adjacent to the opening of the housing. The plug may be connected to the outlet end of the sleeve by complementary threads; however, other methods of connecting the plug and the sleeve may be used. The ring gear can be connected to the outlet end of the sleeve by using a connector that is mechanically fastened to the ring gear and configured for mating receipt of the outlet end of the sleeve. In certain embodiments, the housing is attached to an expander and the inlet end is configured for the receipt of production materials, such as rubber intermediates used in tire production, from the expander.

In another embodiment, the present invention provides an adjustable die for processing a tire construction material that includes a housing. The housing defines a conduit and a housing outlet for the release of tire construction material. A constrictor is included that has an inlet end and an outlet end. The constrictor is configured for receipt by or into the conduit of the housing. The constrictor has a plurality of closely spaced apertures and also has at least one open-flow aperture that is separate from the plurality of closely spaced apertures. A drive mechanism is provided that is in mechanical communication with the constrictor and is configured for moving the constrictor so that the plurality of closely-spaced apertures and the at least one open-flow aperture may be selectively placed in fluid communication with the housing outlet.

In yet another embodiment, the present invention provides an adjustable die for use with an expander for processing rubber and water materials. This exemplary embodiment includes an inner sleeve that defines a first end and a second end that are connected by an interior passage. The sleeve defines a plurality of closely spaced apertures along a side of the sleeve and also defines a single aperture that is positioned along another side of the sleeve apart from the plurality of closely spaced apertures. An outer element defines a conduit into which the inner sleeve is rotatably received. The outer element also defines an outlet that may be selectively placed in fluid communication with the interior passage by rotation of the inner sleeve. A positioning element is provided in mechanical communication with the second end of the inner sleeve. The positioning element is configured for rotating the inner sleeve relative to the outer element such that the plurality of closely spaced apertures and the single aperture may be selectively placed in fluid communication with the outlet of the outer element.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates an exemplary expander head and die head set up employing three separate die heads and a relief valve.

FIG. 2 illustrates an exploded perspective view of an exemplary embodiment of an adjustable die head according to the present invention.

FIGS. 3A, 3B, and 3C illustrate a perspective view (from line 3-3 of FIG. 1) of an exemplary embodiment of the present invention with arrows A and B indicating adjustment.

FIGS. 4A and 4B illustrate a cross-sectional view of an exemplary embodiment of the present invention taken along line 4-4 of FIG. 1. Arrows C of FIG. 4B depicts the flow of material therethrough.

Repeat use of reference characters throughout the present specification and appended drawings is intended to represent same or analogous features or elements of the invention.

### DETAILED DESCRIPTION OF THE PREFERRED EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

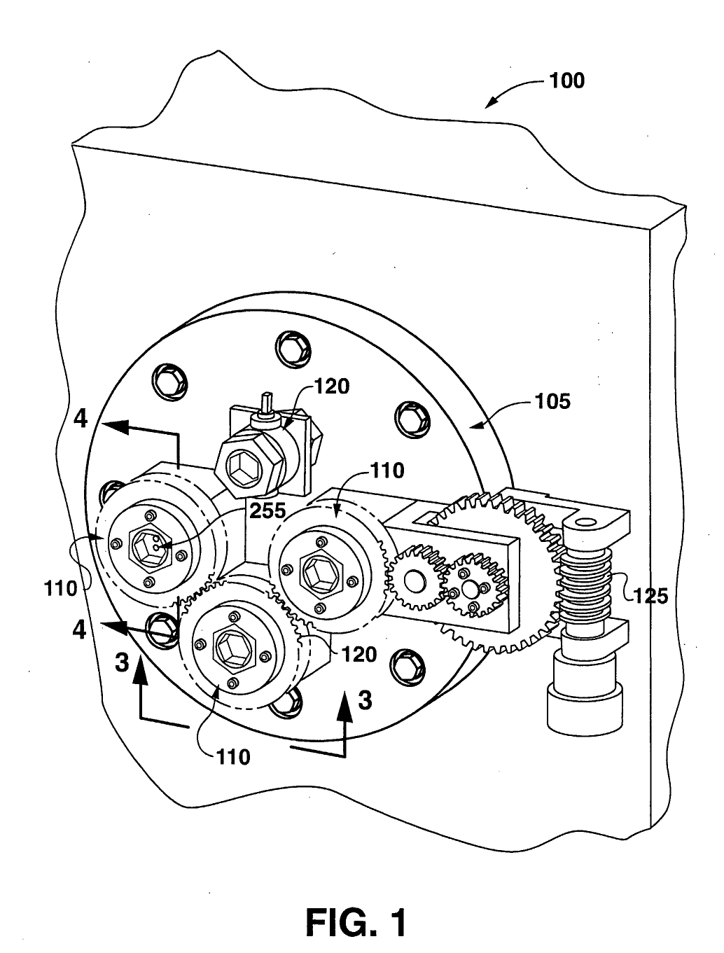

Referring to FIG. 1, there is illustrated an exemplary expander 100 with expander head 105 that is configured with three separate die heads 110. It should be appreciated that, although three die heads 110 are illustrated in the present configuration, such is exemplary only and the number of die heads 110 may vary depending on processing requirements such as the specific type of elastomer being processed. Shown also is a relief valve port 120 for protection in the event of an over-pressure of the equipment and for manually releasing pressure in expander head 100 as desired.

Die heads 110 each include a ring gear 115 having a plurality of teeth 120. Each ring gear 115 is in mechanical communication with other ring gear 115 by teeth 120. Accordingly, rotation of any particular gear 115 occurs in coordination with the rotation of the other ring gears 115. Furthermore, for the exemplary embodiment being described, rotation of ring gear 115 will adjust flow rate from, and therefore pressure and temperature in, expander 100. More specifically, rotation of worm gear 125 causes transfer gears 130, 135, and 140 to rotate. In turn, ring gears 115 rotate and thereby adjust die heads 110 through the operation of elements that will be described below. The rotation of worm gear 125 may be effected manually or by coupling worm gear 125 with a power source such as, for example, an electric motor or hydraulics. Automated controls may also be employed to allow for selective or automatic adjustment during operation of expander 100. For example, an accompanying control mechanism may be associated with expander 100 for automatically controlling the flow rate through die heads 110 so as to meet the desired processing requirements. As illustrated by this exemplary embodiment, the present invention allows such adjustments to be made dynamically, i.e. during operation of expander 100

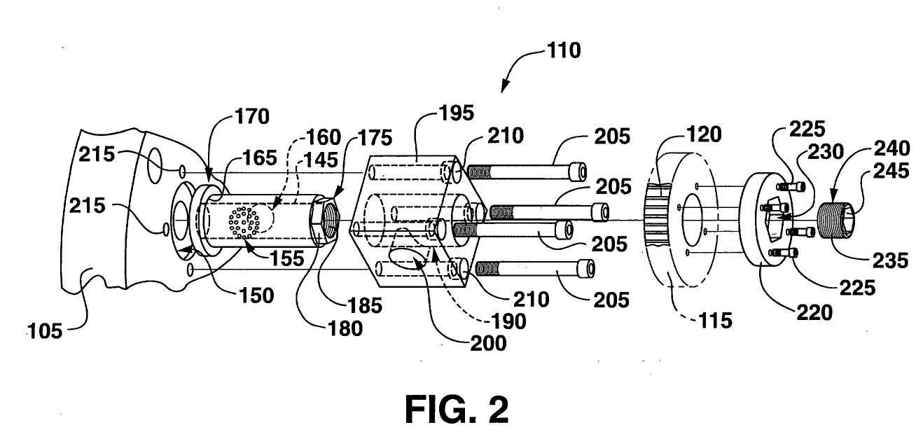

FIG. 2 shows an exploded view of exemplary die head 110. A cylindrically-shaped sleeve or constrictor 145 fits into a recess 150 in expander head 105. Constrictor 145 includes a plurality of closely spaced apertures 155 on one side and an oppositely placed single, larger aperture 160. A flange 165 is positioned on the inlet end 170 of constrictor 145. Flange 165 rests upon and is rotatable within recess 150, which acts to otherwise prevent lateral displacement of flange 165. Outlet end 175 is configured with a hexagonal external feature 180 and internal threads 185, the purpose of which is to be described.

Constrictor 145 is received within conduit 190 defined by housing 195. Conduit 195 is also configured such that constrictor 145 may rotate with housing 195. Housing 195 also defines housing outlet 200, which defines a fluid path that is normal to the length of conduit of 195. Housing 195 is secured to expander head 105 using four bolts 205 that extend through apertures 210 and fasten into threaded openings 215.

Ring gear 115 is positioned between connector 220 and housing 195. Connector 220 is mechanically fastened to ring gear 115 using four bolts 225 and has a hexagonally-shaped opening 230 configured for the receipt of outlet end 175 of constrictor 145. Accordingly, as ring gear 115 is rotated, connector 220 causes constrictor 145 to rotate relative to housing 195.

A plug or insert 235 is received into outlet end 175 of constrictor 145. Threads 240 on insert 235 are configured for complementary receipt by internal threads 185 of constrictor 145. Hexagonally shaped recess 245 provides for the insertion or removal of insert 235 from outlet end 175.

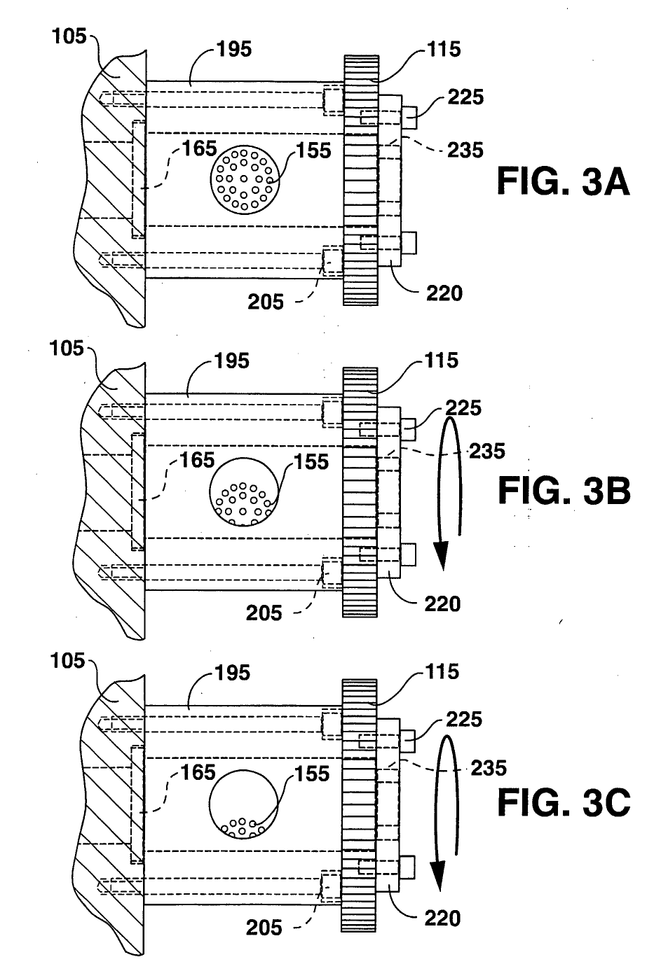

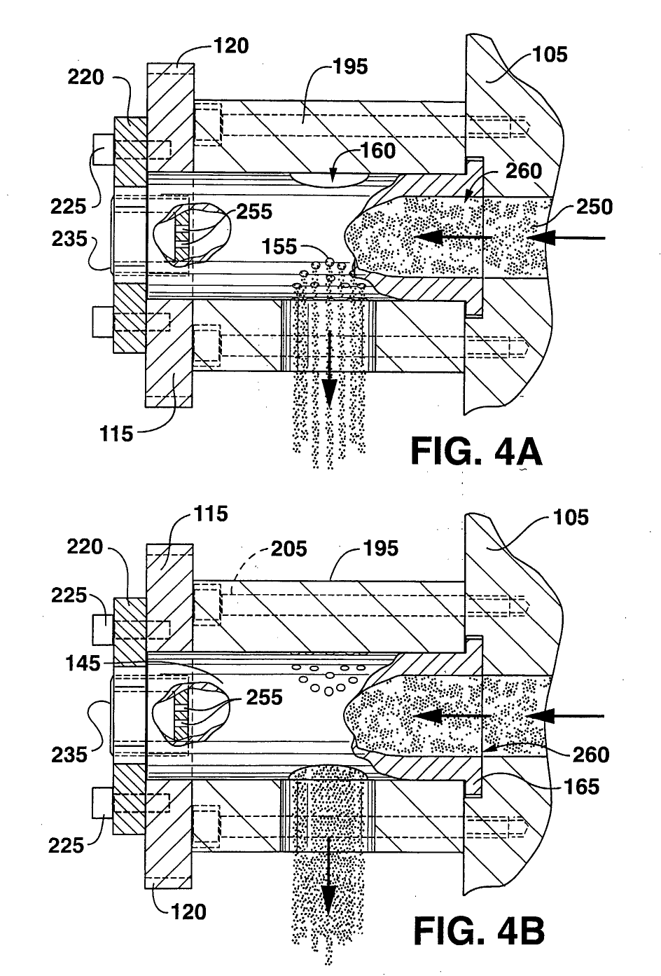

FIGS. 3A, 3B, and 3C illustrate a perspective view (from line 3-3 of FIG. 1) of die head 110. FIGS. 4A and 4B illustrate a cross-sectional view of die head 110 taken along line 4-4 of FIG. 1. Referring now specifically to FIG. 3A, die head 110 is shown with the plurality of closely-spaced apertures 155 positioned adjacent to housing outlet 200. In such position, materials exit expander 100, enter the inlet end 170 of constrictor 145, exit constrictor 145 through apertures 155, and then pass from housing 195 by way of housing outlet 200. Arrows C in FIG. 4A illustrate this movement of rubber and water materials 250 through die head 110.

As material exits through apertures 155, a substantial pressure drop occurs, which in turn creates a flash drying effect as superheated water in materials 250 vaporizes upon reaching atmospheric pressure. As previously mentioned, the energy necessary to produce the flash drying effect is transferred to the materials 250 being processed from a screw drive in expander 100. This energy is provided in the form of elevated pressures and temperatures created by the resistance to material 250 exiting die heads 110 as expander 100 continues to apply pressure. The amount of resistance, and thus the pressure and temperature of material 250, is controlled primarily by the regulating the volume of flow allowed to exit from expander 100.

Such regulating is achieved by controlling the number of apertures 155 that are in fluid communication with housing outlet 200. As indicated by arrows A and B in FIGS. 3B and 3C, as ring gear 115 is rotated, the number of apertures 155 open to housing outlet 200 can be modified to control the volume of material 250 exiting die head 110. Arrows A and B illustrate rotation of constrictor 145 such that the number of apertures 155 in fluid communication with housing outlet 200 is reduced. Such reduction decreases the flow of material 250 from expander 100, which will generally result in an increase of temperature and pressure of materials 250 during operation. To increase the flow of material 250, and thereby reduce temperature and pressure, the number of aperture 155 exposed to housing outlet 200 would be increased. As previously discussed, for an expander 100 having multiple die heads 110 as shown in FIG. 1, these operations can be performed simultaneously for each die head 100 through rotation of worm gear 125 as previously described. Applicant has found that die head 110 can be closed, through rotation of constrictor 145, using less force than is required for other die assemblies. Such rotation can be made dynamically during operation of expander 100, thereby allowing dynamic control of process variable during operation.

For certain applications, applicant has obtained favorable results with a constrictor having a set of 24 closely spaced apertures 155 with each having a diameter of about ⅛ inch. In addition, for certain rubber materials 250, applicant has been able to more effectively reduce the production of fines and produce more favorable particle sizes using die head 110. Furthermore, housing 195 and flange 165 can be readily configured for replacement of existing dies used on current expanders.

Some applications may require that a continuous flow of material from die head 110 be provided at all times. In such case, as shown in FIGS. 4A and 4B, insert 235 may include one or more channels 255 in fluid communication with the interior passage 260 created by constrictor 145. Channels 255 allow for continuous flow of materials 250 from expander 100. As insert 235 is readily replaceable, a variety of inserts can be provided that having any number of apertures or none at all.

During startup or cleanout of expander 100, it may be desirable to provide for an open flow of materials 250 through housing outlet 200. For such applications, constrictor 145 is provided within single aperture 160 that may be rotated such that it is adjacent to housing outlet 200, thereby placing interior passage 260 in fluid communication with housing outlet 200. As shown in FIG. 4B for example, aperture 160 is larger than any of the individual apertures making up plurality of apertures 155 and is also sized to be coextensive with housing outlet 200. As such, aperture 160 allows for a maximum flow setting of die head 110 that may be desired when attempting to clear materials from expander 100, clean expander 100, or otherwise provide for a more open flow.

Accordingly, and in summary, by rotation of ring gear 115, die head 110 allows for flexibility in the operation of expander 100. More particularly, flow though housing outlet 200 may be closed, opened completely through aperture 160, or restricted by selecting the number of apertures 155 in fluid communication with outlet 200. Such operations can be performed dynamically. Applicant has found that the force required to dynamically control expander 100 using exemplary die head 110 is significantly less that with prior constructions. As such, the present invention is more amenable to being equipped with manual, powered, and/or automated control systems.

While the present subject matter has been described in detail with respect to specific embodiments thereof, it will be appreciated that those skilled in the art, upon attaining an understanding of the foregoing may readily produce alterations to, variations of, and equivalents to such embodiments. For example, while the present invention has been described in use with drying mixtures containing elastomeric particles, the present invention is not so limited. By way of further example only, while FIG. 1 illustrates three dies heads 110 in use with expander 100, it should be understood that one or multiple die heads 110 may be used. Additionally, different configurations can be readily envisioned, using the teachings disclosed herein, for rotating ring gear 115. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

1-20. (canceled)

21. An adjustable die for use with an expander for processing rubber and water materials, comprising:
an inner sleeve defining an first end and a second end that are connected by an interior passage,
said sleeve defining a plurality of closely spaced apertures along a side of said sleeve,
said sleeve also defining a single aperture that is positioned along another side of said sleeve apart from said plurality of closely spaced apertures;
an outer element defining a conduit into which said inner sleeve is rotatably received, said outer element defining an outlet that may be selectively placed in fluid communication with said interior passage by rotation of said inner sleeve; and
a positioning element in mechanical communication with said second end of said inner sleeve, said positioning element being configured for rotating said inner sleeve relative to said outer element such that said plurality of closely spaced apertures and said single aperture may be selectively placed in fluid communication with said outlet of said outer element.

22. An adjustable die for use with an expander for processing rubber and water materials as in claim 21, wherein said inner sleeve includes a flange at said first end that is configured for receipt by the expander.

23. An adjustable die for use with an expander for processing rubber and water materials as in claim 21, further comprising a removable plug located within said second end of said inner sleeve.

24. An adjustable die for use with an expander for processing rubber and water materials as in claim 23, wherein said removable plug defines at least one opening in fluid communication with said interior passage.

25. An adjustable die for use with an expander for processing rubber and water materials as in claim 21, further comprising a connector that is mechanically fastened to said positioning element and said second end of said inner sleeve such that rotation of said positioning elements causes said inner sleeve to rotate relative to said outer element.

26. An adjustable die for use with an expander for processing rubber and water materials as in claims 21, further comprising a power source for causing said positioning element to rotate.

27. An adjustable die for use with an expander for processing rubber and water materials as in claim 26, further comprising a controller in communication with said power source for selectively rotating said inner sleeve to predetermined positions.

28. A method for removing water from a mixture of water and rubber materials, the method comprising the steps of:
applying pressure to the mixture of water and rubber;
causing the mixture of water and rubber to flow into a constrictor, the constrictor having a plurality of openings through which the mixture of water and rubber may exit the constrictor;
adjusting the pressure of the mixture of water and rubber in the constrictor by changing the number of the plurality of openings through with the mixture may exit the constrictor, and
rapidly reducing the pressure of the mixture of water and rubber by causing the mixture to exit through the plurality of openings of the constrictor

29. A method for removing water from a mixture of water and rubber materials as in claim 28, wherein said adjusting step comprises rotating the constrictor.

30. A method for removing water from a mixture of water and rubber materials as in claim 28, wherein said plurality of openings are located proximate to each other on the constrictor.
